(19) United States
(12) Patent Application Publication
(10) Pub. No.: US 2006/0101102 A1
(43) Pub. Date: May 11, 2006

(54) Method for organizing a plurality of documents and apparatus for displaying a plurality of documents

(75) Inventors: Zhong Su, Beijing (CN); Li Zhang, Beijing (CN); Yue Pan, Beijing (CN); Li Bai, Beijing (CN); Li Ping Yang, Beijing (CN)

Correspondence Address: RICHARD M. GOLDMAN, 371 ELAN VILLAGE LANE, SUITE 208, CA, 95134, US

(73) Assignee: International Business Machines Corporation, Armonk, NY (US)

(21) Appl. No.: 11/267,985

(22) Filed: Nov. 7, 2005

(30) Foreign Application Priority Data
Nov. 9, 2004 (CN) 200410092369.6

(51) Int. Cl. G06F 12/00; G06F 17/30

(52) U.S. Cl. 707/205

(57) ABSTRACT

The present invention relates to a method for organizing a plurality of documents and an apparatus for displaying a plurality of documents. Said plurality of documents are clustered, and the resulted clusters of different levels are displayed as virtual directories, thus helping the user to navigate to the target document quickly. The navigation may be performed with the aid of topics and abstracts. Furthermore, the user's operations may be reduced through controlling the displayed contents to be within the size of the screen.

### TECHNICAL FIELD

The present invention relates to processing of large collection of documents, especially to a method for organizing a plurality of documents and an apparatus for displaying a plurality of documents.

### BACKGROUND OF THE INVENTION

With the evolution of the Internet, contents on it are booming quickly. Search engine is the most powerful tool to help people in finding out the information they want. However, it seems that getting useful information is becoming more and more difficult because of the vast amount of information. Most of the key word search will result in tons of related items, while people do not even have patient to finish glancing at them.

Also, it would be a difficult and time-consuming task for any user to browse a large collection of documents, such as browse documents in a file system, or browse documents returned from search results.

The problem here is how to organize a large number of documents in an effective manner, and how to display vast amount of documents with the best browsing efficiency. The problem often arises on the search engine site, E-business site and other large-scale sites, and also arises in individual computers, such as when browse a file system in HDD, or when browse a data base recorded in a CD.

A search engine can easily find hundreds of related items, however, there can be only limited items displayed on one HTML page. Traditional search engines use the following display methods:

increasing content in one HTML page

add hyper links

increasing page numbers

But none of them can really improve the user's browsing efficiency. Extra long HTML page on the browser requires the user to type page-down or use mouse dragging scroll bar to view the rest part of it In the same way, clicking the hyper link will also count the page number. Although the search engine has ranked the result items, the user often fails to find the item he wants in the first several pages. It is found that most people will lose their patients before the sixth page. So, actually, result items after the six pages are all meaningless. Some web sites (e.g. Google) use page number to allow user to jump to the specific page without glancing at them one by one. However, without the knowledge of items distribution, the user can only picks the page randomly, this can do little to improve the display efficiency.

A similar problem exists in browsing a large number of files in individual computers: the user always has to turn pages.

Either in individual computers, or in search engines, there are prior arts in which the objects are organized with directories (or folders, or hyperlinks). However, such directories are predetermined and it is unable to predict how many documents have been or will be put into the respective directories. Consequently, the directories often contain large numbers of documents also, and it is difficult to browse.

### SUMMARY OF THE INVENTION

To solve the problem, one object of the invention is to provide a method for organizing a plurality of documents, which may serve as the basis of displaying documents more efficiently.

A further object of the invention is to provide a method and an apparatus for displaying documents efficiently.

For achieving the first object mentioned above, the invention provides a method for organizing a plurality of documents, comprising: clustering said plurality of documents; organizing those documents having common features into respective clusters based on the result of the clustering; clustering the documents contained in the respective generated clusters, and organizing those having common features into respective finer clusters.

For achieving the second object mentioned above, the invention provides a method for displaying documents, which method is constructed on the basis of the method for organizing documents as described above, comprising: displaying on the user interface the clusters of different levels as virtual folders or virtual directories, each of which contains virtual folders or virtual directories of the clusters of lower level, the virtual folders or virtual directories of the clusters of the lowest levels contain titles of documents.

Wherein the upper bound of the number of clusters in each level and the upper bound of the number of documents in each cluster of the lowest level may be designated by the user, or may be determined automatically by the user apparatus based on the display settings of the display device and the contents to be displayed. If the number of documents in a cluster of a current lowest level is greater than a corresponding upper bound, then the documents in the cluster are further clustered so as to generate clusters of lower level, until the number of documents contained in each cluster of the lowest level is smaller than said upper bound. If the number of the documents is smaller than the upper bound, then the titles of the documents are displayed directly. According to the invention, it is preferable that each displayed page only displays those clusters or document titles directly belonging to the same cluster of the higher level, and the contents of the page to be displayed are not clustered until the page is displayed.

According to a preferred embodiment, upon receiving a display instruction, the clusters of the highest level or the document titles of the highest level are first displayed; when a cluster is selected, then the documents contained in the cluster is further clustered, and the sub-clusters or document titles contained in that cluster are displayed based on the clustering result; when a document title is selected, then the content of the document is displayed.

According to a preferred embodiment, the upper bounds mentioned above are so determined that the content of each page displaying the clusters or document titles may be entirely encompassed in a single display screen.

Furthermore, the topics of respective clusters or documents may be concurrently displayed at corresponding positions, wherein the topics may be composed of predetermined number of features having the biggest weights in the feature vector, obtained by clustering, of the respective clusters or documents. The topics of the clusters or documents may be modified according to the topics of their parent clusters.

Furthermore, the abstracts of respective clusters or documents may be concurrently displayed at corresponding positions, wherein the abstracts may be obtained by the following steps: calculating the weights of sentences on the basis of the weights, obtained by clustering, of the keywords in the sentences; and composing the abstracts with a predetermined number of sentences having the biggest weights in the documents or the clusters. The abstracts of the clusters or documents may be modified according to the abstracts of their parent clusters.

According to a preferred embodiment, the weights of the sentences may be computed by use of the keywords obtained in analyzing the topics, and the abstracts may be composed of a predetermined number of sentences having the biggest weights in the documents or the clusters.

For achieving the second object mentioned above, the invention further provides an apparatus for displaying a plurality of documents, comprising: clustering means for: clustering said plurality of documents, organizing those documents having common features into respective clusters based on the result of the clustering, clustering the documents contained in the respective generated clusters, and organizing those having common features into respective finer clusters; a display device for dynamically displaying on the user interface said plurality of documents, document titles or clusters; and a controller for controlling said display device to display the clusters of different levels as virtual folders or virtual directories, each of which contains virtual folders or virtual directories of the clusters of lower level, the virtual folders or virtual directories of the clusters of the lowest levels contain titles of the documents.

According to the invention, it is possible to organize documents more efficiently, so as to facilitate more effective displaying and browsing documents.

### BRIEF DESCRIPTION OF THE DRAWINGS

The preferred embodiments of the invention will be described in details below with reference to the accompanied drawings, wherein:

FIG. 1 is an example of a tree formed by a document organizing method of the present invention;

FIGS. 2 to 5 are examples of contents displayed on the screen, for illustrating a preferred embodiment of the document displaying method according to the invention;

FIG. 6 is a flowchart for illustrating the operation steps of a preferred embodiment of the document displaying method according to the invention;

FIG. 7 is a schematic view for illustrating a preferred embodiment of the document displaying apparatus of the invention;

FIG. 8 is schematic views for illustrating how to manage the document repository shown in FIG. 7.

### DETAILED DESCRIPTION OF THE PREFERRED EMBODIMENTS

The basic idea of the present invention is to maximize the browsing efficiency in the sense of finding a document item with the least number of operations. To this end, the document items are no longer organized flatly; instead, they can be organized in a direct graph by using clustering method. Consequently, the documents items may be no longer displayed flatly.

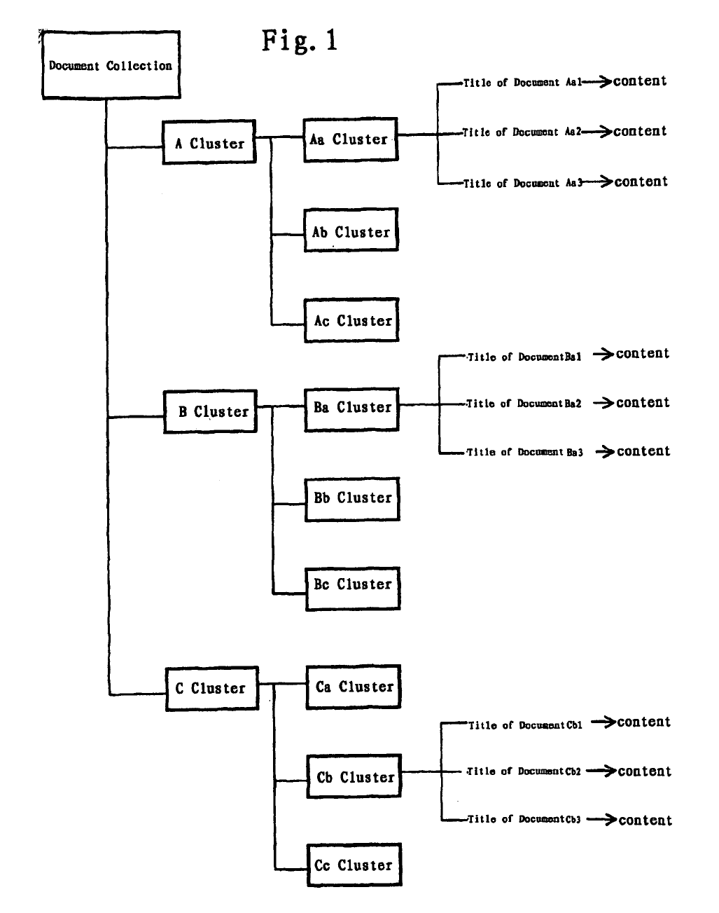

FIG. 1 is an example of a tree formed by a document organizing method of the present invention. In the method, the collection of the large number of documents (document collection) is clustered. As an example, as shown in FIG. 1, the collection of documents are clustered into 3 clusters: Cluster A, Cluster B and Cluster C. That is, any document in the document collection belongs to one of the three clusters, with the documents in each cluster possessing common features. The documents contained in each of said clusters may be further clustered, those having common features are organized respectively into finer clusters. As an example, Cluster A may be further clustered into Cluster Aa, Cluster Ab and Cluster Ac, Cluster B may be further clustered into Cluster Ba, Cluster Bb and Cluster Bc, and so on and so forth. The objects contained in a cluster of the lowest level, such as Cluster Aa in this example, are the final documents, or document titles (e.g., the titles of Document Aa1, Document Aa2 and Document Aa3) pointing to contents of the documents. Obviously, it would be easy to understand that the number of clusters in each level may be arbitrary, and the number of the cluster levels may also be arbitrary. In addition, for sake of simplicity, the drawings do not show all the document titles in all the clusters of the lowest level.

What is shown in FIG. 1 is a tree formed by clustering the document collection. However, the clusters structure may comprise not only the tree, but may be any no circle direct graph (each cluster is a node of the no circle direct graph). For example, the same document may be clustered into different clusters. Similarly, the same cluster of a lower level may also be clustered into clusters of different higher levels. The no circle direct graph can be generated dynamically or pre-designed manually.

Clustering is a unsupervised learning method in Data mining area. Given the number of target clusters N, clustering algorithm can divided the input data set, such as a set of document features, into N categories. Each cluster has a Represented feature vector. By comparing the document feature with the represented feature vector, we can determine this document belonging to which cluster. The “clustering method” can be an auto-clustering technology by computer or a clustering method by manual. The auto-clustering technology by computer includes clustering technologies which generate the cluster structure automatically and auto-categorization technologies which have pre-designed cluster structure. Clustering technologies may include hierarchical clustering, such as single-link clustering, complete-link clustering and group-average clustering etc. Auto-categorization technologies may include naive bayes categorization, SVM (Support Vector Machine) categorization, KNN (K-Nearest Neighbour) categorization etc.

In the present invention, any clustering method in the prior art may be adopted, the following is the simplest basic clustering method.

Denote the document collection as D, which is composed by a set of documents. The feature vector fi of each document di of D has been extracted (i is a natural number, representing the serial number of the documents). Then each document di will be represented by a vector in feature space.

Techniques for extracting features have been mature techniques in the prior art and there are many versions. In natural language processing area, the features are keywords in the document. All the features extracted from the document set construct the feature space. Each keyword represent one dimension. Feature extraction is to transform the plain text to a data point in the vector space. Generally, the plain text is firstly segmented into tokens (tokens can be a word, or a phrase), then the stop words (such as “am” “is” “are”) are deleted from the token list, the remaining tokens are used to represent the document vector. The simplest method is using binary vector, that means, for each dimension, if the word occurs in the document, then the value is 1. Otherwise, is 0. There are also many complicated method to do the transformation, such as using a float value to indicate the importance of the term to the document, the feature value can be represented by tf*idf, wherein tf is the occurrence frequency of the term in the document, and idf is the inverse of the occurrence frequency, in the document collection, of the documents containing the term.

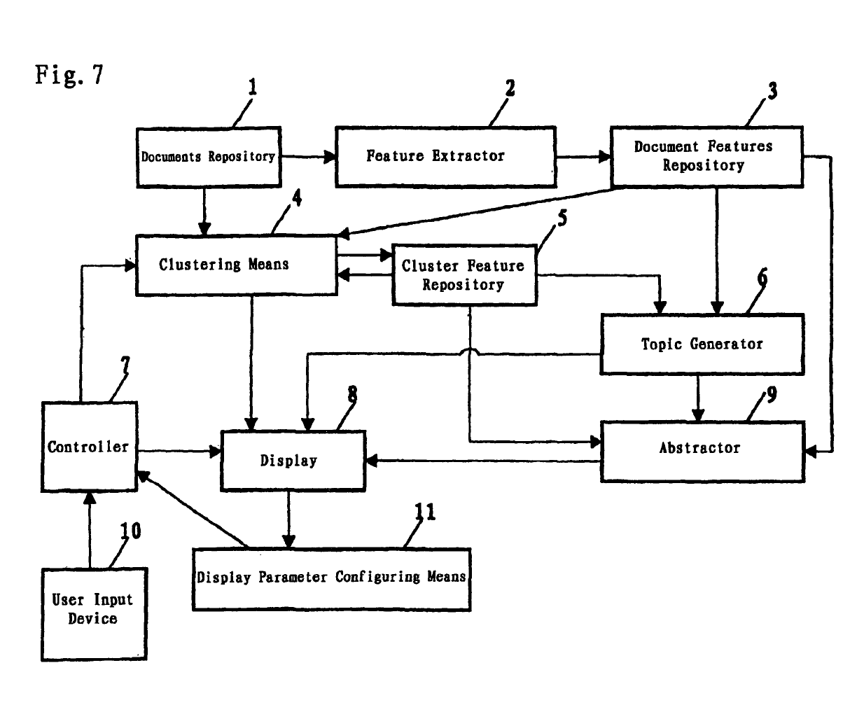

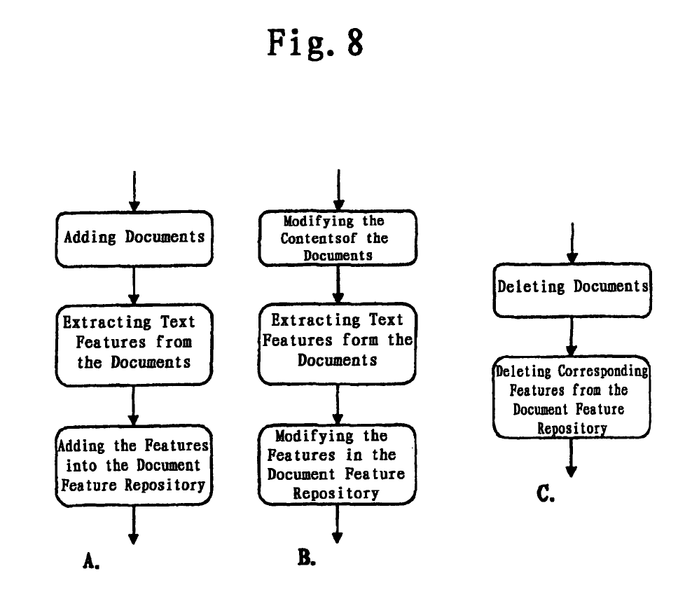

In the present description and the attached claims, as the basis of the clustering algorithm, feature extracting serves as a part of the clustering. However, in practice, the features may be extracted in advance by pre-processing the document collection, and the features (feature vector) of the documents may be stored in specific document feature repository (see FIG. 7). Obviously, the document collection is often dynamically changing, such as some documents are added, the contents of some documents are modified, or some documents are deleted. In this case, the document feature repository need to be maintained accordingly: extracting the features of the newly added documents and adding the extracted features into the document feature repository (FIG. 8A); extracting the features of the modified documents and modifying the corresponding features in the document feature repository (FIG. 8B); or deleting some of the features in the document feature repository (FIG. 8C).

However, in practice, it is often the case that it's necessary to integrate the feature extracting into the clustering algorithm, so that when processing some document collections that have not be pre-processed, the clustering may be started from the feature extracting phase.

As mentioned above, there are many clustering algorithms in the prior art. The following is an implementation of a simple clustering algorithm: K-means algorithm. In the algorithm, the final number (k) of clusters is given by the user, and the data collection is divided into k clusters, each of which is represented by its “gravity center” (k-means) or a point (feature vector, k-medoid) closest to the “gravity center”. Each point (feature vector) is assigned to the cluster represented by the “gravity center” closest to said point. Generally, the algorithm starts with an initial division, and the division is iteratively performed to the data, with the clustering quality optimized by means of controlling policy, until a certain condition is met. The following is a simplified flow of the algorithm:

1. Assuming that the data is to be clustered into K clusters. K cluster gravity centers Z₁(1), Z₂(1), . . . , Zₖ(1) are manually (artificially) determined;

2. In the k-th iteration, the sample set {Z} is clustered as follows:

for i=1, 2, . . . , K, i≠j,

if ∥Z−Zⱼ(k)∥<∥Z−Zᵢ(k), then ZεSⱼ(k)

3. Let the new cluster gravity center of Sⱼ(k) obtained in above Step 2 is Zⱼ(k+1):

minimize

$${J}_{j} = {\sum }_{Z ∈ {S}_{j} ( k )} {‖ Z - {Z}_{j} ( k + 1 ) ‖}^{2} ( j = 1 , 2 , … , K ) ,$$

resulting in that:

$${Z}_{j} ( k + 1 ) = \frac{1}{{N}_{j}} {\sum }_{Z ∈ {S}_{j} ( k )} Z ,$$

Nⱼ is the number samples in Sⱼ(k)ₒ

4. For j=1, 2, . . . , K, if Zⱼ(k+1)−Zⱼ(k) is sufficiently small, then the clustering algorithm is terminated; otherwise go back to Step 2.

Note that the number of clusters may be determined not manually (artificially), but determined by the clustering algorithm itself on the basis of predetermined policies or conditions. In this aspect there are also many prior arts.

Above has been described a new document organizing method in which the items are organized no longer flatly, but organized as directed graph with clustering algorithm. With such a organizing method, the documents may be managed more efficiently. In particular, the method may serve as the basis of a document browsing method provided by the invention for browsing documents more efficiently.

The document browsing method will be described in details below.

According to the invention, based on the results of the process as described above, the clusters of different levels are displayed on the user interface as virtual folders or virtual directories, containing virtual folders or virtual directories of clusters of the lower level, with the virtual folders or virtual directories of clusters of the lowest level containing the titles of documents. As shown in FIG. 1, the clusters from the highest level (A to Cluster Cs) to the lowest level (Aa, Ab, . . . , Cb, Cluster Ccs) may be displayed on the user interface as virtual folders or virtual directories, and/or the document titles and/or document contents may be displayed on the screen. Obviously, similar to conventional directory (folder) management, for example, virtual directories of different levels may be displayed in the left portion of the screen, and the content in the current directory of the lowest level may be displayed in the right portion of the screen. Alternatively, what is displayed in the left portion may be down to the titles of the documents, and what is displayed in the right portion may be directly the content of one document. Similar to conventional directory management, the tree constituted by the virtual directories of different levels may be unfolded or folded.

As discussed in the background of the invention, the problem of page turning in the prior art is extremely troublesome. For solving the problem, according to a preferred embodiment of the invention, the user may designate the upper bound of the number of the clusters in respective levels and the upper bound of the number of documents in a cluster of the lowest level, if the number of documents contained in a cluster of the current lowest level is greater than said upper bound, then the documents in said cluster is further clustered so as to generate clusters of lower level, until the number of documents contained in each cluster of the lowest level is smaller than said upper bound; if the number of all the documents is smaller than said upper bound, then the titles of the documents are directly displayed. The above operations aim to ensure that the items (clusters (virtual folders) or document titles) in each level will not be too large, and thus be able to displayed in one single screen on the user interface, without needing page turning. Again as shown in FIG. 1, the upper bound may be set, for example, as 3 (certainly it may be set as, for example, 10). Thus, when all the virtual directories of lower levels are folded, such as when a user browses a document collection for the first time, all the virtual directories of the highest level would surely be displayed in one single screen. When the user hopes to further browse a certain virtual directory (such as Cluster A) and unfold its virtual sub-directories (such as Clusters Aa to Ac), the virtual sub-directories would surely be displayed in one singe screen, and so on and so forth.

According to the invention, the upper bound may also be automatically set by the user apparatus on the basis of the display settings of the display device and the contents to be displayed. This is advantageous for, unless the user is rich in experience, the user usually is unable to estimate how many contents could be displayed in one single screen, consequently it's hard to optimize the browsing efficiency. Specifically, the operation of automatic setting needs to take the following factors into account: the size of the screen (or display area), display resolution, the font size of the display and the contents to be displayed. Obviously, if these factors are known, it would be easy to a person skilled in the art to calculate how many clusters or how many document titles a single screen could contain.

However, for some reasons, it is possible that the display area occupied by a certain display item will exceed intended area. For example, it will be the case when the size of the display content for each cluster or document title is not fixed, and the whole content of the relevant document title (or topic or abstract as described later) is displayed. In such a case, said upper bound needs to be adjusted. For example, the user apparatus may set a upper bound, for example, 10 items per screen, on the basis of the default conditions. If, on a certain screen, it is found out that 10 items will exceed one screen, then the user apparatus modifies said upper bound as 9, and so on and so forth, until the contents could be contained in one single screen.

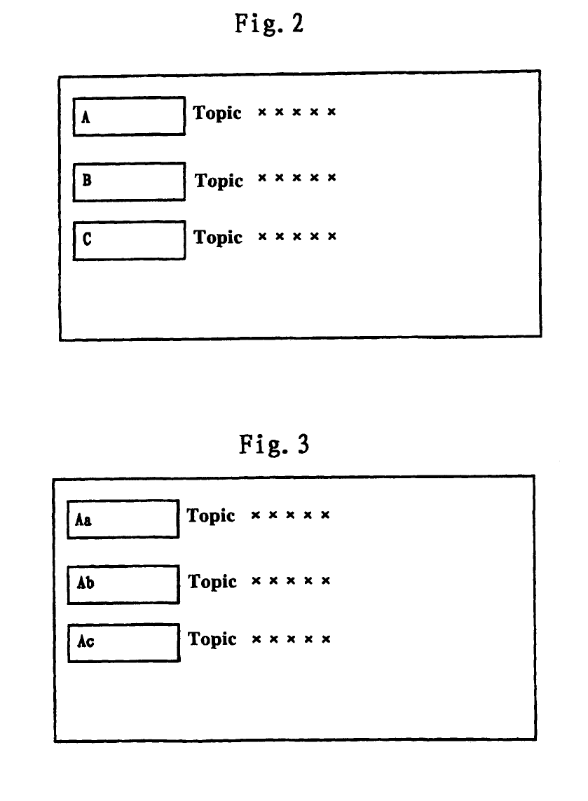

Further, for improving more the browsing efficiency and the utilization efficiency of the display, or when the using habituation is different (such as in browsing the Internet, generally the items are organized as hyperlinks, not as directory tree as in the explorer in individual computers), each display page may only displays the clusters or document titles directly belonging to the same cluster of higher level. FIGS. 2 to 5 show examples (base on the example shown in FIG. 1) of the display area in the user interface. Upon receiving a display instruction, that is, when the user begins to browse the document collection, such as the search result of a search engine (a search result is a document collection organized temporarily by the search engine), the display screen shown in FIG. 2 is first presented to the user, on which a specified number (designated by the user or automatically set by the user apparatus, such as 3) of clusters of the highest level (A Cluster to Cluster C) and their topics (which will be described later) are listed.

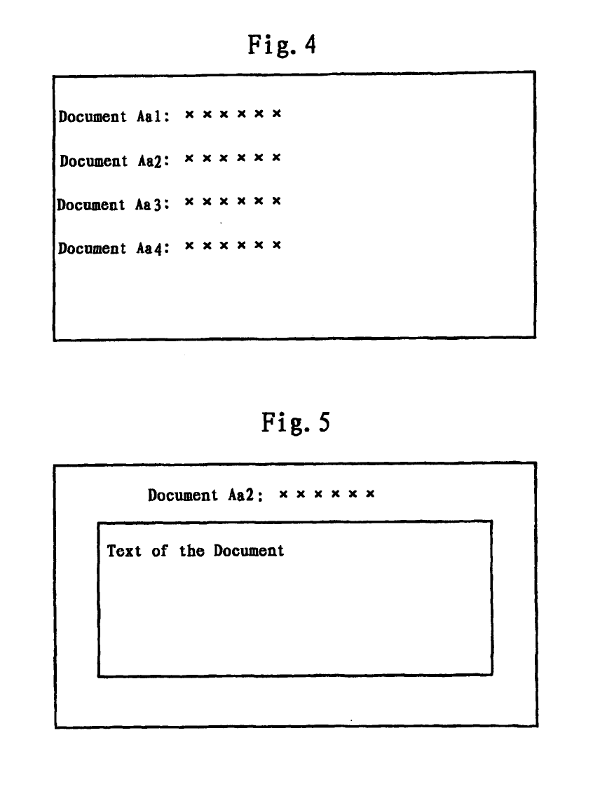

When the user selects a cluster such Cluster A, then a screen containing Clusters Aa to Ac (and their topics) comprised in Cluster A are displayed (FIG. 3). Similarly, if Cluster Aa is selected, then the document titles Aa1 to Aa5 (and their topics) contained therein are displayed (FIG. 4). Finally, if the user selects a document, such as Document Aa2, then its text is displayed (FIG. 5).

Obviously, depending on the number of documents in the document collection, the features of the documents and the upper bound defined as above, the final number of the cluster levels is indefinite. The example shown in the drawings contains 2 cluster levels, but more or less cluster levels are possible. When the number of the documents is so small that their topics (and topics) could be displayed in one single screen, then the first screen will directly display said document titles (and topics).

To save the computing resource and time, in the display processing as discussed above, the contents of a page will not be clustered until the page is to be displayed. That is, a page is clustered only when it's to be displayed. As a specific example, in FIG. 1, the clusters of the highest level, Cluster A to Cluster C, are initially displayed. Only when the user hopes to expand Cluster A, will the documents contained in Cluster A be further clustered and the clustering result Clusters Aa-Ac be displayed, with the contents contained in Cluster B and Cluster C not being further clustered. It's similar in FIGS. 2 to 5. In the example shown in the drawings, only Cluster A is further clustered, and no further clustering operation is performed on the documents contained in Cluster B and Cluster C.

As mentioned above, the topics of respective clusters or documents may be displayed at corresponding positions, so that the user may browse clusters of interest according to the keywords of the topics.

Topic detection method is also a well-known method in the prior art, and has many forms. For example, JP2000259666 (“Topic Extraction Device”, Ichiro et al.) disclosed a topic extraction system, in which the topic of a certain cluster is expressed with noun phrases having relatively higher appearance frequency, and the documents are sorted on the basis of said noun phrases so as to be provided to the user.

In the present invention, the generation of the topics may also be based on the feature vectors obtained in the clustering. That is, for a cluster or a document the topic of which is to be generated, the dimensions in the feature vector obtained in the clustering is quickly sorted, and the topic of said cluster or document is comprised of a predetermined number of word items having the greatest weights in the feature vector.

The topic of said cluster or document may be modified on the basis of the topic of its parent cluster. For example, since the user has already known the topic of the parent cluster, it's meaningless but time consuming to repeat said topic in the sub-clusters or documents. Therefore, when generating the topic of a sub-cluster or a document, some or all of the keywords in the topic of the parent cluster may be excluded first.

Furthermore, the topic may be replaced with an abstract, or an abstract may be displayed in addition to the topic. There are also many prior arts for generating an abstract for single document or for multiple documents.

In the present invention, the abstractor may be configured with the keywords in the topic as discussed above. That is, the weight of each sentence in a cluster or a document is computed based on the weights of the keywords contained in its topic, then a predetermined number of sentences having the greatest weights are selected to form an abstract. When computing the weight of a sentence, the length and frequency and etc. of the sentence may also be taken into account.

In the present invention, the abstract may also be generated independent from the generation of the topic. As the keywords for generating the abstract, another predetermined number of features having the greatest weights in the feature vector as the result of the clustering may be selected. Based on said keywords, the weights of sentences are computed, and the abstract is generated.

Similar to the generation of the topic, the abstract of said cluster or document may be modified on the basis of the topic and/or abstract of its parent cluster, by, for example, decreasing the importance in the abstract to be generated of the contents of the topic or abstract of the parent cluster, such as excluding some or all of the sentences appearing in the abstract of the higher level, or not considering some of all of the keywords in the topic of the parent cluster when configuring the abstractor, and etc.

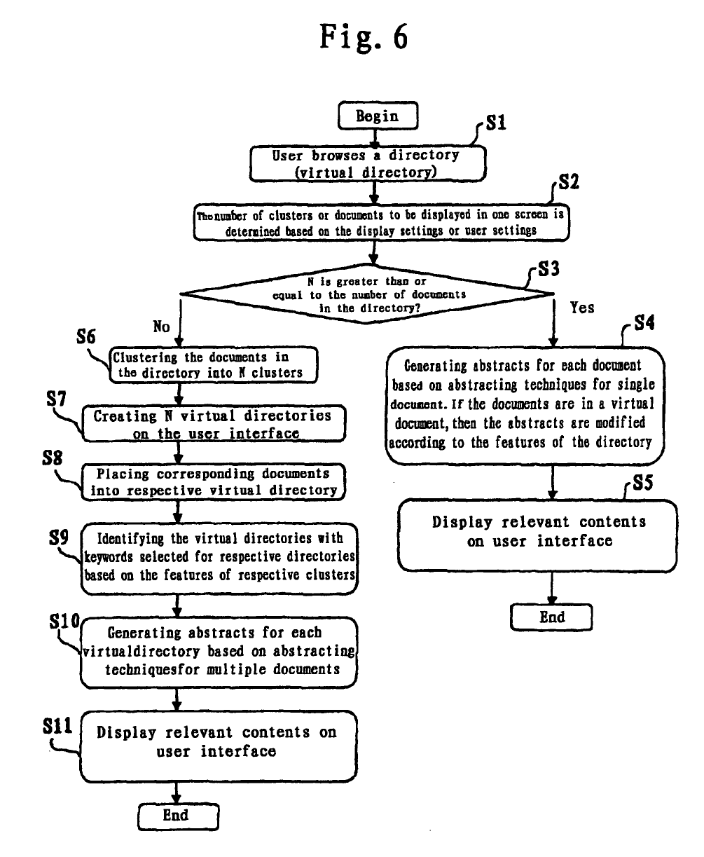

Above have described various embodiments of the document organizing method and the document displaying method according to the invention. FIG. 6 shows an example of the operations in a preferred embodiment of the method according to the invention, which embodiment comprises most of the features as described above.

As shown in FIG. 6, in Step S1, the user issues a command for browsing a directory (an “operation” can be a mouse click, mouse dragging, keyboard typing, voice command etc.). The command may be a command for browsing a real directory by the user, or browsing a virtual directory (such as Cluster A, Cluster Aa and etc. as shown in FIGS. 1 to 5). The command can also be other commands like a command for rendering a search engine to perform a search.

In Step S2, based on the display settings of the display device (and the contents to be displayed), or based on the selection of the user, the number N of clusters or documents to be displayed in one single screen is determined.

In Step S3, N is compared with the number of documents contained in said directory. If N is greater than the number of documents, then in Step S4, abstracts (and/or topics) are generated for each document. If the directory where the documents are is a virtual directory according to the invention, then the contents of the abstracts (and/or topics) for each document are modified on the basis of the features (such as feature vector, topic, abstract and etc.) of said virtual directory, and are displayed in Step S5.

If the comparison result in Step S3 is N is smaller than the number of documents, then in Step S6, the documents in the directory are clustered into N clusters, and N corresponding virtual directories are created on the user interface in Step S7, and the corresponding documents are placed into respective virtual directories (Step S8). Next, keywords may be selected according to the feature vector of each cluster and used to form topics of respective virtual directories (Step S9). More detailed abstracts may be further generated for each virtual directory (Step S10) and the relevant contents may be displayed on the user interface (Step S11).

When the user selects a virtual directory according to the contents displayed on the user interface, then the process is iterated from Step S1.

Note that as described above with reference to FIGS. 1 to 5, not all of the above steps are indispensable, and the sequence of the steps is also adjustable. For example, automatic clustering may be performed instead of Steps S2, S3, S4 and S5. Alternatively, the number N may be fixed before the step S1, and thus there may be no Step S2. In addition, the steps S4, S9 and S10 for generating topics or abstracts are not indispensable, either. Furthermore, in the document organizing method, it is sufficient to iteratively perform Steps S6 and S8, and depending on conditions, there may be Steps S2 and/or S3.

Corresponding to above method, the invention further provides an apparatus for displaying multiple documents. FIG. 7 shows a preferred embodiment of the apparatus for implementing the preferred embodiment of the above-described document displaying method. The apparatus comprises the following components:

1. Clustering means 4 for clustering the multiple documents in a documents repository 1, and organizing those documents having common features into respective clusters. The cluster means 4 further clusters the documents contained in said clusters and organizing those having common features into finer clusters. The feature vectors of the clusters, as the result of the clustering operation, may be held in a cluster feature repository 5. A feature extractor 2, which may serve as a part of the clustering means 4 or as a preprocessing means independent from the clustering means 4, may pre-process the documents in the document repository 1, the resulted feature vectors of the documents may be held in the document feature repository 3.

2. A display device 8 for dynamically displaying on the user interface said plurality of documents, document titles or clusters under the control of a controller 7 as will be described. On the basis of the control of the controller 7, the display device 8 may further display the topics and/or abstracts of respective clusters or documents at corresponding positions. The topics and abstracts are generated respectively by the topic generator 6 and abstractor 9 as will be described below.

3. A user input device 10 for designating by the user the upper bound of the number of clusters of each level and the upper bound of the number of documents in each cluster of the lowest level.

4. Display parameter configuring means 11 for determining, according to the display settings of the display device and the contents to be displayed, the upper bound of the number of clusters of each level and the upper bound of the number of documents in each cluster of the lowest level. Said upper bounds may be determined so that the contents of each page for displaying the clusters or documents could be totally encompassed within the screen of the display device 8.

5. A topic generator 6 for, based on the clustering results, generating the topics of respective clusters or documents from a predetermined number of features having the greatest weights in the feature vectors of respective clusters or documents. When generating the topics of the clusters or documents, the topic generator 6 may be configured to modify the topics of said clusters or documents according to the topics of the parent clusters.

6. An abstractor 9 for computing the weights of sentences on the basis of the weights of the keywords contained in the topics generated by the topic generator 6 and composing abstracts from a predetermined number of sentences having the greatest weights in a document or cluster. Alternatively, the abstractor 9 may be configured to, based on the results of the clustering operations, calculate the weights of the sentences based on the weights of the keywords in the sentences and compose an abstract from a predetermined number of sentences having the greatest weights in the document or cluster. The abstractor 9 may be further configured to modify the abstract of the cluster or document according to the topic and/or abstract of the parent cluster.

7. A controller 7 for controlling said display device 8 and clustering means 4.

Wherein, said controller 7 controls said display device to display the clusters of different levels as virtual folders or virtual directories, each of which containss virtual sub-directories or virtual sub-folders, and the virtual directories or virtual folders of the lowest level contains document titles.

The controller 7 may be further configured so that if the number of document in a cluster of the lowest level is greater than the upper bound input from the user input device 10 or the upper bound set by the display parameter configuring means 11, then the documents therein are further clustered into finer clusters, until the number of documents contained in each cluster of the lowest level is smaller than said upper bound. If the total number of the documents is smaller than said upper bound, then the controller 7 controls said display device 8 to display the document titles directly.

In addition, said controller 7 may control said display device 8 to only display in each page the clusters or document titles belong directly to the same parent cluster, and may control said clustering means 4 so that the contents to be displayed in a page are not clustered before said page is displayed. Furthermore, upon receiving display instruction, the controller 7 controls said display device to first display the page of the clusters or document titles of the highest level. When a cluster is selected through the user input device 10, then the clustering means 4 is controlled to cluster the documents contained in the selected cluster, and display the clusters or document titles contained in the selected cluster according to the result of the clustering operation. When a document title is selected through the user input device 10, then the display device 8 is controlled to display the content of the selected document.

Note that the document repository 1 is the object to be processed by the method and apparatus of the invention, not a component of the apparatus of the invention. The cluster feature repository 5 is a component of the clustering means 4. In addition, although the feature extractor 2 and the document feature repository 3 may be implemented as independent pre-processing means, they may serve as components of the clustering means 4.

The construction as described above is a preferred embodiment of the apparatus according to the invention. Obviously, similar to the method as discussed afore, not all of the components as mentioned above are indispensable. In the strict sense, only the clustering means 4, the display device 8 and the controller 7 are indispensable for the invention. Any one among or any combination of the user input device 10, the display parameter configuring means 11, the topic generator 6 and the abstractor 9 may, together with the clustering means 4, the display device 8 and the controller 7, constitute various embodiments, corresponding respectively to various embodiments of the method as described afore.

A person skilled in the art would appreciate that some or all of the steps of the method, or some or all of the components of the apparatus, may be realized by hardware, firmware and/or software or any combination thereof in any computing apparatus (including a processor and storage medium and etc.) or network of computing apparatus, and may be realized by any person skilled in the art who has read the present specification and has basis programming skills.

Thus, according to the preferred embodiment of the invention, when the user browse a large collection of documents, such as when the user searches a certain item and as the search result a large number of documents are picked out, the user will see the top cluster page first, and then are navigated by the cluster page to the content page by the aid of the topics and abstracts. In this way, the user does not need to view other irrelevant content pages (and even other irrelevant cluster pages). Meantime, the preferred embodiment of the invention always use one screen page to display information, the users don't need type page-down over and over, all he needs to do is focusing on the current screen.

As an advantageous result, the user can easily find out any specific item among a vast amount of displayed items within limited pages and through limited operations. If each screen page displays 20 cluster items, given 3M items existing on the web, a user can usually find a specific item in less than 4 operations and 5 screen pages (20⁵=3200000), without viewing other unrelated items.

Therefore, the invention will make the user feel more friendly and more conveniently when browsing large document collections such as when browsing Internet pages.

1. A method for organizing a plurality of documents, comprising:
clustering said plurality of documents;
organizing those documents having common features into respective clusters based on the result of the clustering;
clustering the documents contained in the respective generated clusters, and organizing those having common features into respective finer clusters.

2. The method of claim 1, characterized in displaying on the user interface the clusters of different levels as virtual folders or virtual directories, each of which contains virtual folders or virtual directories of the clusters of lower level, wherein the virtual folders or virtual directories of the clusters of the lowest levels contain titles of documents.

3. The method of claim 2, characterized in that, the upper bound of the number of clusters in each level and the upper bound of the number of documents in each cluster of the lowest level are designated by the user, wherein, if the number of documents in a cluster of a current lowest level is greater than its upper bound, then the documents in the cluster are further clustered so as to generate clusters of lower level, until the number of documents contained in each cluster of the lowest level is smaller than said upper bound; if the number of the documents is smaller than the upper bound, then the titles of the documents are displayed directly.

4. The method of claim 2, characterized in that, the upper bound of the number of clusters in each level and the upper bound of the number of documents in each cluster of the lowest level are determined automatically by the user's apparatus based on the display settings of the display device and the contents to be displayed, wherein, if the number of documents in a cluster of a current lowest level is greater than its upper bound, then the documents in the cluster are further clustered so as to generate clusters of lower level, until the number of documents contained in each cluster of the lowest level is smaller than said upper bound; if the number of the documents is smaller than the upper bound, then the titles of the documents are displayed directly.

5. The method of claim 3, characterized in that each displayed page only displays those clusters or document titles directly belonging to the same cluster of the higher level, and the contents of the page to be displayed are not clustered until the page is displayed.

6. The method of claim 5, characterized in that, upon receiving a display instruction, the clusters of the highest level or the document titles of the highest level are first displayed; when a cluster is selected, then the documents contained in the cluster is further clustered, and the sub-clusters or document titles contained in that cluster are displayed based on the clustering result; when a document title is selected, then the content of the document is displayed.

7. The method of claim 6, characterized in that said upper bounds are so determined that the content of each page displaying the clusters or document titles can be entirely encompassed within a single display screen.

8. The method of claim 6, characterized in that the topics of respective clusters or documents are concurrently displayed at corresponding positions, wherein the topics are respectively composed of a predetermined number of features having the biggest weights in the respective feature vectors, obtained by clustering, of the respective clusters or documents.

9. The method of claim 8, characterized in that the topics of the clusters or documents are modified according to the topics of their parent clusters.

10. The method of claim 8, characterized in that the abstracts of respective clusters or documents are concurrently displayed at corresponding positions, wherein the weights of the sentences are computed by use of the weights of the keywords contained in said topics, and the abstracts are respectively composed of a predetermined number of sentences having the biggest weights in the documents or the clusters.

11. The method of claim 10, characterized in that the abstracts of the clusters or documents are modified according to the abstracts and/or topics of their parent clusters.

12. The method of claim 6, characterized in that the abstracts of respective clusters or documents are concurrently displayed at corresponding positions, wherein the weights of the sentences are computed on the basis of the weights, obtained by clustering, of the keywords in the sentences, and the abstracts are respectively composed of a predetermined number of sentences having the biggest weights in the documents or the clusters.

13. The method of claim 12, characterized in that the abstracts of the clusters or documents are modified according to the abstracts and/or topics of their parent clusters.

14. An apparatus for displaying a plurality of documents, comprising:
clustering means for: clustering said plurality of documents, organizing those documents having common features into respective clusters based on the result of the clustering, clustering the documents contained in the respective generated clusters, and organizing those having common features into respective finer clusters;
a display device for dynamically displaying on the user interface said plurality of documents, document titles or clusters; and
a controller for controlling said display device to display the clusters of different levels as virtual folders or virtual directories, each of which contains virtual folders or virtual directories of the clusters of lower level, the virtual folders or virtual directories of the clusters of the lowest levels contain titles of the documents.

15. The apparatus of claim 14, characterized in further comprising:
a user input device for designating by the user the upper bound of the number of clusters of each level and the upper bound of the number of documents in each cluster of the lowest level,
wherein the controller are further configured so that if the number of document in a cluster of the lowest level is greater than said upper bound, then the clustering means is controlled to further cluster the documents in said cluster into finer clusters, until the number of documents contained in each cluster of the lowest level is smaller than said upper bound; if the total number of the documents is smaller than said upper bound, then the display device is controlled to display the document titles directly.

16. The apparatus of claim 14, characterized in further comprising:
display parameter configuring means for determining, according to the display settings of the display device and the contents to be displayed, the upper bound of the number of clusters of each level and the upper bound of the number of documents in each cluster of the lowest level.
wherein the controller are further configured so that if the number of document in a cluster of the lowest level is greater than said upper bound, then the clustering means is controlled to further cluster the documents in said cluster into finer clusters, until the number of documents contained in each cluster of the lowest level is smaller than said upper bound; if the total number of the documents is smaller than said upper bound, then the display device is controlled to display the document titles directly.

17. The apparatus of claim 15, characterized in that said controller is further configured to control said display device to only display in each page the clusters or document titles belong directly to the same parent cluster, and control said clustering means o that the contents to be displayed in a page are not clustered before said page is displayed.

18. The apparatus of claim 17, characterized in that said control is further configured to, upon receiving display instruction, control said display device to first display the page of the clusters or document titles of the highest level; when a cluster is selected through the user input device, then control the clustering means to cluster the documents contained in the selected cluster, and control the display device to display the clusters or document titles contained in the selected cluster according to the result of the clustering operation; when a document title is selected through the user input device, then control the display device to display the content of the selected document.

19. The apparatus of claim 16, characterized in that said display parameter configuring means is further configured to so determine said upper bounds that the contents of each page for displaying the clusters or documents could be totally encompassed within the screen of the display device.

20. The apparatus of claim 16, characterizing in further comprising:
a topic generator for, based on the clustering results, generating the topics of respective clusters or documents from a predetermined number of features having the greatest weights in the feature vectors of respective clusters or documents,
wherein the controller is further configured to control said display device to display concurrently the topics of respective clusters or documents at corresponding positions.

21. The apparatus of claim 20, characterized in that said topic generator is further configured to modify the topics of said clusters or documents according to the topics of the parent clusters.

22. The apparatus of claim 20, characterized in further comprising:
an abstractor for computing the weights of sentences on the basis of the weights of the keywords contained in the topics generated by the topic generator and composing abstracts from a predetermined number of sentences having the greatest weights in a document or cluster,
wherein the controller is further configured to control said display device to display concurrently the abstracts of respective clusters or documents at corresponding positions.

23. The apparatus of claim 22, characterized in that said abstractor is further configured to modify the abstract of the cluster or document according to the topic and/or abstract of the parent cluster.

24. The apparatus of claim 18, characterized in further comprising:
an abstractor for, based on the results of the clustering operations, calculating the weights of the sentences based on the weights of the keywords in the sentences and composing an abstract from a predetermined number of sentences having the greatest weights in the document or cluster,
wherein the controller is further configured to control said display device to display concurrently the abstracts of respective clusters or documents at corresponding positions.

25. The apparatus of claim 24, characterized in that said abstractor is further configured to modify the abstract of the cluster or document according to the topic and/or abstract of the parent cluster.
